(19) United States
(12) Patent Application Publication
(10) Pub. No.: US 2010/0039065 A1
(43) Pub. Date: Feb. 18, 2010

(54) Apparatus and Method for Employing High Value Capacitor in Starting Applications

(76) Inventor: Charles E. Kinkade, JR., Warren, MI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/191,670

(22) Filed: Aug. 14, 2008

(51) Int. Cl. H02J 7/00

(52) U.S. Cl. 320/104

(57) ABSTRACT

A vehicle battery boosting device to jump start a battery. The device includes a bank of ultracapacitors, a high current relay, a charge circuit, a voltage monitor and a management circuit. The voltage monitor can monitor voltage at the charge circuit and the bank of ultracapacitors and the high current relay to determine status of the various components of the device. The device can be incorporated into a battery tester and charger cart.

### FIELD OF THE INVENTION

The present invention relates generally to a device for starting a vehicle. More particularly, the present invention relates to using capacitors to boost a vehicle's battery.

### BACKGROUND OF THE INVENTION

A discharged vehicle battery can be remedied by allowing the battery to charge using the vehicle's recharging system (if the vehicle can be started) or through the use of a conventional battery charger. A vehicle typically requires 200-300 Amps provided by the battery in order for the vehicle to start. A typical battery charger in a battery service center can provide around 75-100 Amps for battery charging, but does not provide enough amps to start the vehicle. Accordingly, it is desirable to provide a power source to start a vehicle when the vehicle's battery is discharged.

### SUMMARY OF THE INVENTION

The foregoing needs are met, to a great extent, by the present invention, wherein in one aspect an apparatus is provided that in some embodiments includes utilizing capacitors to provide the boost needed to start a vehicle.

In accordance with one embodiment of the present invention, a portable vehicle battery booster is provided, which can comprise a bank of ultracapacitors that provides boosting power to the battery, a high current relay that makes a connection between a booster terminals at the battery and the bank, a charge circuit that charges the bank, a voltage monitor that monitors voltage at the charge circuit, voltage rise of the bank, and the voltage at the terminals, a management circuit that communicates with the voltage monitor, the relay and the charge circuit, and a housing to house the bank, the relay, the charge circuit, the voltage monitor and management circuit.

In accordance with another embodiment of the present invention, a method of boosting a vehicle battery is provided, which can comprise of connecting a battery boosting device having a bank of ultracapacitors, a high current relay, a charge circuit, a voltage monitor and a management circuit, monitoring a voltage at a connection between the battery boosting device and the battery with the voltage monitor to determine a status of the connection, determining if the bank is ready for boosting with the management circuit, and boosting the battery with the boosting device if the bank is ready.

In accordance with yet another embodiment of the present invention, a portable vehicle battery booster is provided, which can comprise a means for powering configured to provide boosting power to a vehicle battery, a means for relaying current configured to make a connection between booster terminals at the battery and the means for powering, a means for charging configured to charge the means for powering, a means for monitoring voltage configured to monitor voltage at the means for charging, voltage rise of the means for powering and the voltage at the terminals, a means for managing configured to communicate with the means for monitoring voltage, the means for relaying current and the means for charging, and a means for housing configured to house the means for powering, the means for relaying, the means for charging, the means for monitoring voltage and the means for managing.

In accordance with still another embodiment of the present invention, a portable vehicle battery booster is provided, which can comprise a bank of ultracapacitors that provides boosting power to a vehicle battery, a relay that makes a connection between a booster terminals at the battery and the bank, a charge circuit that charges the bank, a voltage monitor that monitors voltage at the charge circuit, voltage rise of the bank and the voltage at the terminals, a battery load tester to test the battery, a battery charger to charge the battery, a management circuit that communicates with the voltage monitor, the relay, the charge circuit, the battery load tester and the battery charger, and a housing to house the bank, the relay, the charge circuit, the voltage monitor, management circuit, the battery load tester and the battery charger.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates an example of an ultracapacitor that can be used according to an embodiment of the invention.

FIG. 2 illustrates six ultracapacitors that are connected in a series to form a bank.

FIG. 3 illustrates a handheld starting device according to an embodiment of the invention.

FIG. 4 illustrates the bank being coupled with a hand held battery tester unit according to an embodiment of the invention.

FIG. 5 illustrates the device being utilized as part of a mobile cart according to an embodiment of the invention.

### DETAILED DESCRIPTION

The invention will now be described with reference to the drawing figures, in which like reference numerals refer to like parts throughout. An embodiment in accordance with the present invention provides utilizing a series of capacitors to provide the necessary amps to start a vehicle.

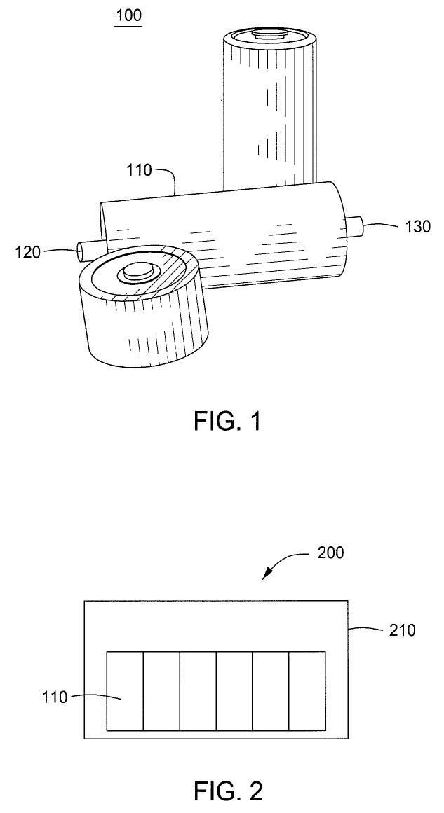

FIG. 1 illustrates an example of an ultracapacitor 110 that can be used according to an embodiment of the invention. The ultracapacitor includes a positive end 120 and a negative end 130. The ultracapacitor includes an electric double-layer and has two non-reactive porous plates suspended within an electrolyte with an applied voltage across the plates. The ultracapacitor can provide the 400-800 A (amps) that may be required to start a vehicle and can be charged at virtually any rate from an existing battery or other power supply. The ultracapacitors can be configured for any amperage needed by the user. Any ultracapacitor can be used with this invention so long it has enough amps by itself or when connected in series or parallel to start a vehicle. One such ultracapacitor is model BCAP0650-P270 (BOOSTCAP™) from Maxwell Technologies, San Diego, Calif.

FIG. 2 illustrates six ultracapacitors that are connected in series to form a bank 200. Although in one embodiment six ultracapacitors are present, there can be as little as one and as many ultracapacitors as needed in a particular application. The ultracapacitors can be contained in a housing 210. The housing is configured to provide the proper ventilation and wired connections as needed in order to connect the bank to a handheld device or placed on a battery charger/tester cart (discussed below). The bank has many advantages over a standard battery used to boost start such as the ultracapacitors can be recharged 1 million times and the output spikes required for starting even large engines in cold conditions are not an issue due to the extremely low internal resistance of the bank.

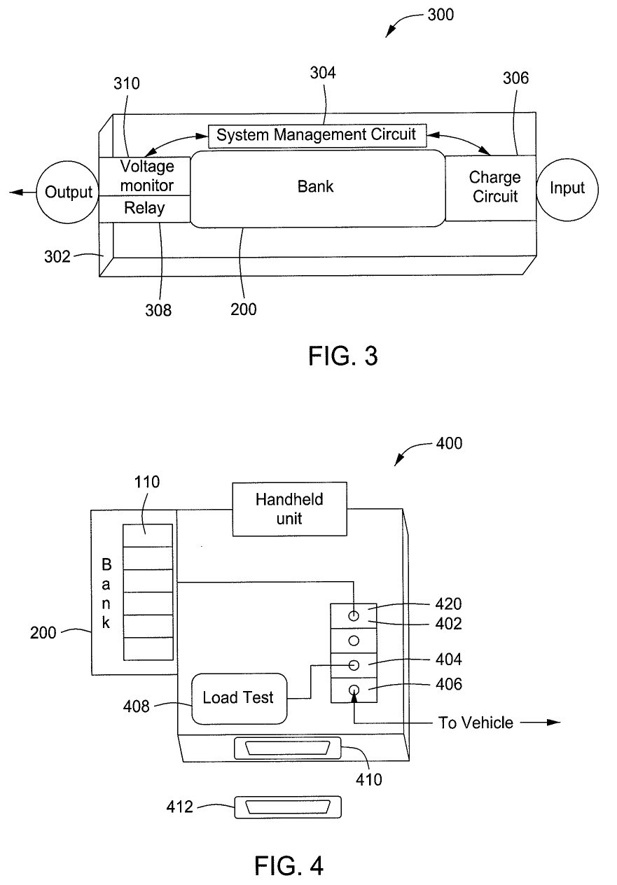

FIG. 3 illustrates a handheld starting device 300 according to an embodiment of the invention. The handheld includes the bank 200, an enclosure 302, a management circuit 304, a charge circuit 306, a high current relay 308, and a voltage monitor 310. The enclosure is configured to contain all or some of the above-mentioned components depending on the design. The management circuit 304 includes a processor and the software required to run the handheld device 300 and the components described herein including the charge circuit, relay and voltage monitor. The management circuit 304 is designed to prevent overcharging of the bank, monitor voltage trends over time and determine if the device is ready for jump starting based on estimated calculations of the energy available by the capacitors at any given time. The management circuit 304 can be used to control system lights or indicators, switches, buzzers or alarms and other components to enhance functionality and safety.

The charge circuit 306 can monitor charging of the bank 200 in conjunction with the voltage monitor 310. The charge circuit 306 would feed data regarding current, voltage, estimated time to full charge and other information to the management circuit 304. Additionally, the charging circuit 306 would relay to the management circuit 304 that the device is charging and can detect any connections issues with the charging source. The charging circuit 306 can act to limit the charging current being supplied by an external power source (AC and DC) due to the low resistance of the ultracapacitors. The power sources can include AC to DC wall adapter charging, DC to DC car adapter charging or battery charger charging at high current. Because of the nearly unlimited charge rate of the ultracapacitors, when the device is coupled to the battery charger, the capacitor charge time can be very slow. Additionally, due to the high efficiencies of charging capacitors over the charging of conventional batteries, less time is involved and less energy is converted into heat.

The high current relay 308 is utilized to make a high current connection between the booster terminals and the bank. For safety reasons, the high current relay 308 can be used with the voltage monitor 310. The voltage monitor 310 can be configured to monitor the input voltage (battery charger or external power source), the voltage rise during charging of the bank, and the voltage at the terminals. More specifically, the voltage monitor 310 along with the management circuit 304 can use the voltage rise data and the voltage level of the bank (charged level) to determine the state of charge of the bank, the time to full charge and the energy level available for boost starting. The voltage monitor 310 along with the management circuit 304 can monitor the voltage at the vehicle side (output) to determine if a good connection has been made at the vehicle's battery terminals. If a good connection is not made between the device and the battery terminals, the boosting of the battery may not occur properly. Additionally, having a good connection would prevent accidental short circuit of the bank. Further, the voltage monitor 310 along with the management circuit 304 can monitor the input voltage on the charging side (input) to determine if the correct DC power adapter is connected to the device. If the 12V adapter is used, a voltage step-up adapter would be used in conjunction therewith. The device 300 in this embodiment can be used as a stand-alone device and is portable.

FIG. 4 illustrates the bank being coupled with a hand held battery tester unit 400 according to an embodiment of the invention. The hand held battery tester 400 includes the bank 200 coupled with the tester unit 400. The tester also includes a relay (100 amps) 420 that connects with the bank 200 at portion 402, the battery load test module 408 at portion 404 and the vehicle at portion 406. The battery load test module can test batteries ranging from 6V to 12V and other voltages. Another component of the unit is a processing unit (not shown) that includes the software required to run the unit, to test the batteries, to provide the boost charge using the bank and other functions of the unit. In one embodiment, the processing unit can be the managing circuit that communicates with the bank 200, the battery load test module 408, the relay 420 and other components of the unit 400. Power to the unit can be provided via connection 410 of the unit to a connection 412 of a charging base (not shown).

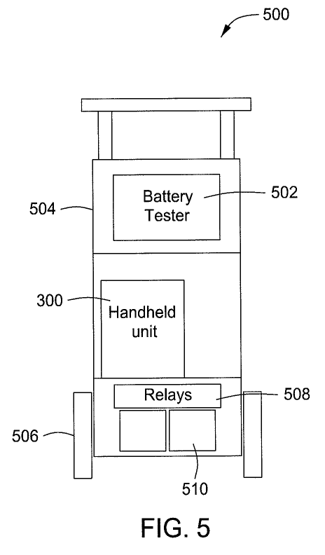

In still another embodiment, FIG. 5 illustrates the device 300 being utilized as part of a mobile cart 500. The cart 500 can include modules for battery testing, battery charging, and battery boosting that are contained in a housing 504. The cart 500 can be moved on wheels 506. The cart 500 can include the battery test unit 400 (without the bank 200) for battery testing, the device 300 for boost starting, the charging modules 510 for charging the vehicle's battery and relays and switches 508 for use for in testing, starting and charging the battery.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A portable vehicle battery booster, comprising:
a bank of ultracapacitors that provides boosting power to the battery;
a high current relay that makes a connection between a booster terminals at the battery and the bank;
a charge circuit that charges the bank;
a voltage monitor that monitors voltage at the charge circuit, voltage rise of the bank, and the voltage at the terminals;
a management circuit that communicates with the voltage monitor, the relay and the charge circuit; and
a housing to house the bank, the relay, the charge circuit, the voltage monitor and management circuit.

2. The booster of claim 1, wherein the bank of ultracapacitors includes six ultracapacitors.

3. The booster of claim 1, wherein the voltage monitor determines whether a good connection is made between the battery and the booster.

4. The booster of claim 1, wherein the voltage monitor determines the state of charge of the bank and the energy level available for boosting.

5. The booster of claim 1, wherein the voltage monitor determines if the correct DC power adapter is connected to the device.

6. The booster of claim 1, wherein the management circuit prevents over charging of the bank.

7. The booster of claim 1, wherein the management circuit using the voltage information of the bank determines if the bank has the capacity for boosting the battery.

8. The booster of claim 1, wherein the charge circuit is configured to charge via an AC to DC, a DC to DC or a battery charger charging at high current connection.

9. The booster of claim 1, wherein the management circuit comprises a processor and a software to perform the functions of the booster device.

10. A method of boosting a vehicle battery, comprising the steps of:
connecting a battery boosting device having a bank of ultracapacitors, a high current relay, a charge circuit, a voltage monitor and a management circuit;
monitoring a voltage at a connection between the battery boosting device and the battery with the voltage monitor to determine a status of the connection;
determining if the bank is ready for boosting with the management circuit; and
boosting the battery with the boosting device if the bank is ready.

11. The method of claim 10 further comprising monitoring the voltage at the charge circuit to determine a charging status of the charging.

12. The method of claim 10 further comprising determining a status of the boosting device with the management circuit communicating with the voltage monitor, the charge circuit and the high current relay.

13. A portable vehicle battery booster, comprising:
a means for powering configured to provide boosting power to a vehicle battery;
a means for relaying current configured to make a connection between booster terminals at the battery and the means for powering;
a means for charging configured to charge the means for powering;
a means for monitoring voltage configured to monitor voltage at the means for charging, voltage rise of the means for powering and the voltage at the terminals;
a means for managing configured to communicate with the means for monitoring voltage, the means for relaying current and the means for charging; and
a means for housing configured to house the means for powering, the means for relaying, the means for charging, the means for monitoring voltage and the means for managing.

14. The booster of claim 13, wherein the means for powering comprises six ultracapacitors.

15. The booster of claim 13, wherein the means for monitoring voltage determines whether a good connection is made between the battery and the booster device.

16. The booster of claim 13, wherein the means for monitoring voltage determines the state of charge of the means for powering and the energy level available for boosting.

17. The booster of claim 13, wherein the means for monitoring voltage determines if the correct DC power adapter is connected to the booster device.

18. The booster of claim 1, wherein the means for managing prevents over charging of the means for powering.

19. The booster of claim 1, wherein the means for managing uses the voltage information of the means for powering to determine if the means for powering has the capacity for boosting the battery.

20. The booster of claim 1, wherein the means for charging is configured to charge via AC to DC, DC to DC or battery charger charging at high current connection.

21. A portable vehicle battery booster, comprising:
a bank of ultracapacitors that provides boosting power to a vehicle battery;
a high current relay that makes a connection between booster terminals at the battery and the bank;
a charge circuit that charges the bank;
a voltage monitor that monitors voltage at the charge circuit, voltage rise of the bank and the voltage at the terminals;
a battery load tester to test the battery;
a management circuit that communicates with the voltage monitor, the relay, the battery load test and the charge circuit; and
a housing to house the bank, the relay, the charge circuit, the voltage monitor, management circuit and the battery load tester.

22. A portable vehicle battery booster, comprising:
a bank of ultracapacitors that provides boosting power to a vehicle battery;
a relay that makes a connection between a booster terminals at the battery and the bank;
a charge circuit that charges the bank;
a voltage monitor that monitors voltage at the charge circuit, voltage rise of the bank and the voltage at the terminals;
a battery load tester to test the battery;
a battery charger to charge the battery;
a management circuit that communicates with the voltage monitor, the relay, the charge circuit, the battery load tester and the battery charger; and
a housing to house the bank, the relay, the charge circuit, the voltage monitor, management circuit, the battery load tester and the battery charger.
